(19) United States
(12) Patent Application Publication
(10) Pub. No.: US 2023/0373873 A1
(43) Pub. Date: Nov. 23, 2023

(54) NOVEL SUGAR- AND PHOSPHORUS-CONTAINING FERTILIZER

(71) Applicant: CHINA AGRICULTURAL UNIVERSITY, Beijing (CN)

(72) Inventors: Gu FENG, Beijing (CN); Yi PENG, Beijing (CN)

(73) Assignee: CHINA AGRICULTURAL UNIVERSITY, Beijing (CN)

(21) Appl. No.: 18/031,525

(22) PCT Filed: Oct. 9, 2021
(86) PCT No.: PCT/CN2021/122827

§ 371 Date: Apr. 12, 2023

(30) Foreign Application Priority Data
Oct. 15, 2020 (CN) 202011102075.2

(51) Int. Cl. C05B 7/00; C05G 5/23; A01C 21/00

(52) U.S. Cl. CPC C05B 7/00; C05G 5/23; A01C 21/00

(57) ABSTRACT

The present disclosure provides a novel sugar- and phosphorus-containing fertilizer. In the present disclosure, based on masses of carbon and phosphorus elements, the novel sugar- and phosphorus-containing fertilizer has a carbon-phosphorus ratio of (1-15):1, and includes a low-carbon type with a carbon-phosphorus ratio of (1-4):1 and a high-carbon type with a carbon-phosphorus ratio of (4-15):1; and a carbon source is any one or more selected from the group consisting of glucose, sucrose, sugarcane molasses, and beet molasses. The novel sugar- and phosphorus-containing fertilizer is applied to the soil by drip irrigation or furrow dressing, and improves a phosphorus utilization efficiency of crops by regulating an activity of inherent phosphorus-solubilizing microorganisms in the soil. After applying the novel sugar- and phosphorus-containing fertilizer in a plurality of test sites, the soil has strengthened respiration, a significantly improved phosphatase activity, an obviously increased water-soluble phosphorus concentration, and remarkably enhanced crop production.

### CROSS REFERENCE TO RELATED APPLICATION

This application is a national stage application of international Patent Application No. PCT/CN2021/122827, filed on Oct. 9, 2021, which claims priority of the Chinese Patent Application No. 202011102075.2, filed on Oct. 15, 2020, both of which are incorporated by references in their entities.

### TECHNICAL FIELD

The present disclosure belongs to the technical field of agricultural planting and chemical fertilizers, and in particular relates to a sugar- and phosphorus-containing fertilizer.

### BACKGROUND

Soil microorganisms play an important role in the activation and utilization of soil phosphorus. Microorganisms may quickly immobilize the phosphate fertilizer applied to the soil in their body to form microbial biomass phosphorus. During a turnover process of the microbial biomass phosphorus, the phosphorus may be released into the soil (Gyaneshwar et al., 2002) and become an important source of soil available phosphorus (Richardson et al., 2009). Phosphatases secreted by phosphorus-dissolving microorganisms may hydrolyze organic phosphorus into orthophosphate for uptake and utilization of plant. Organic acid anions secreted by microorganisms may chelate phosphate radical precipitated by metal cations. Proton secretion by microorganisms and CO₂ released through respiration may also reduce the pH value of rhizosphere soil, thereby promoting the dissolution of insoluble phosphate (Meyer et al., 2019). However, agricultural soil is a carbon-limited environment for the growth of soil microorganisms. The vast majority of microorganisms are in a state of “carbon starvation” (Demoting et al., 2007; Groffman and Fisk, 2011), and only about 5% of the soil microorganisms are active. Therefore, it has become a hot and difficult issue of theoretical researches in the field of soil fertilizers to promote the metabolic activity of microorganisms and enhance the conversion and turnover of phosphorus by microorganisms through adding suitable carbon sources. This reduces a loss of effectiveness of the phosphate fertilizer applied to the soil and improves a utilization efficiency of the phosphate fertilizer.

The ratio of carbon to phosphorus is a key factor to regulate the biological activation and turnover of phosphorus by soil microorganisms. In principle, it is recognized that in an environment where carbon sources are relatively scarce, an increment of the ratio of carbon to phosphorus in soil may increase the activity of alkaline phosphatase and the abundance and diversity of bacterial functional groups containing phoD (Luo et al., 2017), as well as promote the activation of organic phosphorus by soil microorganisms (Spohn et al., 2013; Zhang et al., 2014; Zhang et al., 2016). Meanwhile, the increment of the ratio of carbon to phosphorus may also increase the soil respiration rate and promote the acidification of local micro-domains of the soil, thereby strengthening the bioavailability of insoluble inorganic phosphorus (Meyer et al., 2019). However, excessive carbon input may also cause a large amount of phosphate fertilizer applied to the soil to be immobilized in microorganisms (Zhang et al., 2018), resulting in a decrease of soil available phosphorus content and inhibiting crop growth. Therefore, the appropriate input ratio of carbon and phosphorus is a key to exert the function of microbial phosphorus solubilization and improve the efficiency of phosphorus utilization. However, so far, there is no specific technical parameter regarding a stoichiometric ratio of carbon and phosphorus for the organic carbon and phosphate in fertilizer products.

Currently, carbon-containing compounds such as glucose, sucrose, and molasses are all used as an additive in the bio-organic fertilizer fermentation and microbial fertilizer production. This additive provides a carbon source for the expansion and reproduction of microbial strains, and does not consider and involve the stoichiometric ratio of carbon and phosphorus in the fertilizer. It may be seen that, in terms of stimulating and promoting the activity and function of indigenous phosphorus-solubilizing microorganisms in farmland soil, previous studies have not offered specific and clear technical parameters for controlling a carbon-phosphorus mass ratio of the carbon-containing compounds and phosphates in fertilizers. There is also no related technology and product for the preparation method and ratio of the carbon-containing compounds and phosphates.

### SUMMARY

In order to avoid the low utilization rate of phosphate fertilizer in production, the present disclosure provides a novel sugar- and phosphorus-containing fertilizer. The sugar- and phosphorus-containing fertilizer regulates the activity of indigenous microorganisms and improves a utilization rate of the phosphate fertilizer.

The present disclosure provides a sugar- and phosphorus-containing fertilizer, including a water-soluble carbon-containing compound and a phosphorus-containing compound; where
a carbon element in the water-soluble carbon-containing compound and a phosphorus element in the phosphorus-containing compound are at a mass ratio of (1-15):1.

In the sugar- and phosphorus-containing fertilizer, the water-soluble carbon-containing compound is at least one selected from the group consisting of glucose, sucrose, sugarcane molasses, and beet molasses; and
the sugarcane molasses and the beet molasses each have a saccharinity of 40% to 100%, specifically 85%;
the phosphorus-containing compound is at least one selected from the group consisting of phosphoric acid and a phosphate;
the phosphate is at least one selected from the group consisting of monoammonium phosphate, diammonium phosphate, potassium dihydrogen phosphate, urea phosphate, and ammonium polyphosphate; and
the ammonium polyphosphate has a polymerization degree of 2 to 10, and may be purchased from Yunnan Tianyao Chemical Co., Ltd.

Specifically, a carbon element in the water-soluble carbon-containing compound and a phosphorus element in the phosphorus-containing compound are at a mass ratio of (1-4):1 (as a low-carbon type) or (4-15):1 (as a high-carbon type).

More specifically, the carbon element in the water-soluble carbon-containing compound and the phosphorus element in the phosphorus-containing compound are at a mass ratio of (1.44-5.71):1, (1.44-3.66):1, (4.58-5.71):1, and (6.58-13.16):1;
when the mass ratio of the carbon element in the water-soluble carbon-containing compound to the phosphorus element in the phosphorus-containing compound is (1.44-3.66):1, the fertilizer is a sugar- and phosphorus-containing fertilizer of the low-carbon type; and the mass ratio may be more specifically 2.45:1;
when the mass ratio of the carbon element in the water-soluble carbon-containing compound to the phosphorus element in the phosphorus-containing compound is (4.58-5.71):1, the fertilizer is a sugar- and phosphorus-containing fertilizer of the high-carbon type;
More specifically, the sugar- and phosphorus-containing fertilizer may be prepared from the water-soluble carbon-containing compound, the phosphorus-containing compound, and water; and
the water and the water-soluble carbon-containing compound are at a mass ratio of (1-3):10.

The present disclosure further provides a method for preparing the sugar- and phosphorus-containing fertilizer, including:
mixing the water-soluble carbon-containing compound, the phosphorus-containing compound, and the water uniformly according to a proportion to obtain the sugar- and phosphorus-containing fertilizer.

Specifically, the method for preparing the sugar- and phosphorus-containing fertilizer includes the following steps:
uniformly mixing a specific amount of the water-soluble carbon-containing compound with the phosphorus-containing compound to obtain the sugar- and phosphorus-containing fertilizer in a powder form; alternatively,
dissolving a specific amount of the water-soluble carbon-containing compound in water to obtain a solution of the water-soluble carbon-containing compound, and then dissolving the phosphorus-containing compound into the solution of the water-soluble carbon-containing compound to obtain the sugar- and phosphorus-containing fertilizer in a liquid form.

More specifically, if the water-soluble carbon-containing compound is the sugarcane molasses in a liquid state (or the beet molasses in a liquid state), a specific amount of the sugarcane molasses (or the beet molasses) in a liquid state is diluted with water, and then the phosphorus-containing compound is dissolved into an obtained molasses solution.

Use of the sugar- and phosphorus-containing fertilizer in fertilization provided by the present disclosure still falls within the protection scope of the present disclosure.

Specifically, during the fertilization, the sugar- and phosphorus-containing fertilizer is applied at 90 kg to 525 kg, specifically 195.0 kg, 415 kg, or 425 kg per hectare of farmland;
the fertilization is conducted on maize, cotton, or alfalfa;
the fertilization is conducted 1 to 3 times; and
the fertilization is conducted by drip irrigation, furrow dressing, or hole application.

Specifically, since the fertilizer is dripped with water during the drip irrigation, and not only a fertilizer solution is dripped into the soil, but also crop irrigation should be taken into account. Therefore, during the drip irrigation, a ratio of the fertilizer to water is not fixed, and an irrigation quota needs to be determined according to the specific situation.

More specifically, when the fertilization is conducted on the maize such as spring maize, the fertilization is conducted by drip irrigation for 3 times;
the time and amount of fertilization for the first to third fertilization are as follows:
the first fertilization is conducted when watering for seedling emergence of maize, at an application amount accounting for 40% of a total amount of the sugar- and phosphorus-containing fertilizer;
the second fertilization is conducted when first drip irrigation is completed after the emergence of maize, at an application amount accounting for 40% of a total amount of the sugar- and phosphorus-containing fertilizer; and
the third fertilization is conducted when third drip irrigation is completed after the emergence of maize, at an application amount accounting for 20% of a total amount of the sugar- and phosphorus-containing fertilizer.

When the fertilization is conducted on the maize such as spring maize, the fertilization is conducted by furrow dressing for 2 times;
the time and amount of fertilization for the first to second fertilization are as follows:
when sowing maize, the fertilization is applied along with a seed fertilizer, at an application amount accounting for 40% of a total amount of the sugar- and phosphorus-containing fertilizer;
when topdressing the maize at a jointing stage, the fertilization is applied at an application amount accounting for 60% of a total amount of the sugar- and phosphorus-containing fertilizer.

When the fertilization is conducted on the cotton, the fertilization is conducted by drip irrigation for 2 times;
the time and amount of fertilization for the first to second fertilization are as follows:
when watering for seedling emergence, the sugar- and phosphorus-containing fertilizer of the low-carbon type is applied at one time; and
when first drip irrigation is completed after the emergence, the sugar- and phosphorus-containing fertilizer of the high-carbon type is applied at one time.

An amount of phosphorus-containing components converted in the sugar- and phosphorus-containing fertilizer of the low-carbon type is 60% of a total amount of phosphorus elements in the sugar- and phosphorus-containing fertilizers of the low-carbon type and the high-carbon type.

Use of the sugar- and phosphorus-containing fertilizer in any one of the following items provided by the present disclosure still falls within the protection scope of the present disclosure:
a, improving an activity of indigenous phosphorus-solubilizing functional microorganisms in the soil;
b, increasing availability of phosphorus in the soil;
c, promoting crop growth; and
d, improving a utilization efficiency of a phosphate fertilizer.

### BRIEF DESCRIPTION OF THE DRAWINGS

FIGS. 1A-C show an impact of applying the novel sugar- and phosphorus-containing fertilizer on maize yield, water-soluble phosphorus concentration, and partial factor productivity (PFP) of phosphate fertilizer; where FIG. 1A is the yields of maize in different treatments; FIG. 1B is the concentrations of water-soluble phosphorus in different treatments; and FIG. 1C is the PFP of phosphate fertilizers in different treatments, herein different lowercase letters indicate that the differences between treatments reach a significant level (P≤0.05);

FIGS. 2A-C show an impact of applying the novel sugar- and phosphorus-containing fertilizer on maize yield, soil acid phosphatase activity, and PFP of phosphate fertilizer; where FIG. 2A is the yields of maize in different treatments; FIG. 2B is the acid phosphatase activities in different treatments, and FIG. 2C is the PFP of phosphate fertilizers in different treatments, herein different lowercase letters indicate that the differences between treatments reach a significant level (P≤0.05);

FIGS. 3A-F show an impact of applying the novel sugar- and phosphorus-containing fertilizer on lint yield (FIG. 3A), PFP of phosphate fertilizer (FIG. 3B), utilization efficiency of phosphate fertilizer (FIG. 3C), soil water-soluble phosphorus concentration (FIG. 3D), soil acid phosphatase activity (FIG. 3E), and soil respiration (FIG. 3F), herein different lowercase letters indicate that the differences between treatments reach a significant level (P≤0.05); and

FIG. 4 shows an application effect of Example 4.

### DETAILED DESCRIPTION OF THE EMBODIMENTS

The present disclosure is further clearly and completely described below in conjunction with specific examples. Apparently, the protection scope of the present disclosure is not limited to the scope expressed in the examples. Anyone may draw other various forms of products under the enlightenment of the present disclosure. However, no matter any changes are made in the types or composition ratios of carbon-containing compounds and chemical phosphate fertilizer raw materials, all technical solutions the same as those of the present application all fall within the scope of protection of the present disclosure. The method is conventional, unless otherwise specified. All raw materials are commercially available, unless otherwise specified.

### Example 1 Novel Sugar- and Phosphorus-Containing Fertilizer for Drip Irrigation of Spring Maize

1. In this example, the novel sugar- and phosphorus-containing fertilizer included the following components with corresponding carbon-to-phosphorus ratios:

The novel sugar- and phosphorus-containing fertilizer 1 (low-carbon type) included: at a carbon-to-phosphorus ratio of 2.45:1, 120 parts of glucose (containing 40% carbon, which was equivalent to 48 parts of carbon). and 75 parts of monoammonium phosphate (containing 60% P₂O₅, which was equivalent to 19.6 parts of phosphorus).

The novel sugar- and phosphorus-containing fertilizer 2 (high-carbon type) included: at a carbon-to-phosphorus ratio of 5.71:1, 280 parts of glucose (containing 40% carbon, which was equivalent to 112 parts of carbon), and 75 parts of monoammonium phosphate (containing 60% P₂O₅, which was equivalent to 19.6 parts of phosphorus).
2. The preparation and application methods included:

The drip irrigation was conducted. During the drip irrigation, the glucose and the monoammonium phosphate of the above parts were fully mixed in proportion, to obtain novel sugar- and phosphorus-containing fertilizer powders with high and low carbon-to-phosphorus ratios. The novel sugar- and phosphorus-containing fertilizer powders were added into a fertilization tank, stirred and mixed evenly, and then subjected to the drip irrigation along with water.
3. A planting mode of the spring maize by drip irrigation under mulch with a target yield of 12 t ha⁻¹ was taken as an example.

The application method of the novel sugar- and phosphorus-containing fertilizer included a type of the novel fertilizer, a total amount of the fertilizer during the whole growth period, and amounts during different growth periods.
(1) The “novel sugar- and phosphorus-containing fertilizer 1 (low-carbon type)” was applied. The novel sugar- and phosphorus-containing-fertilizer per hectare of farmland was applied to the soil in three times, at 195.0 kg ha⁻¹ (which was equivalent to the total amount of carbon and phosphorus of 67.7 kg ha⁻¹, and the phosphorus-containing components of 19.6 kg P ha⁻¹).

The first fertilization was conducted when watering for seedling emergence of maize, at an application amount accounting for 40% of a total amount of the fertilizer (the amount of the novel sugar- and phosphorus-containing fertilizer was 78.0 kg ha⁻¹, which was equivalent to 27.1 kg ha⁻¹ in the total amount of carbon and phosphorus);
the second fertilization was conducted when first drip irrigation was completed after the emergence of maize; at an application amount accounting for 40% of a total amount of the fertilizer (the amount of the novel sugar- and phosphorus-containing fertilizer was 78.0 kg ha⁻¹, which was equivalent to 27.1 kg ha⁻¹ in the total amount of carbon and phosphorus); and
the third fertilization was conducted when third drip irrigation was completed after the emergence of maize, at an application amount accounting for 20% of a total amount of the fertilizer (the amount of the novel sugar- and phosphorus-containing fertilizer was 39.0 kg ha⁻¹, which was equivalent to 13.5 kg ha⁻¹ in the total amount of carbon and phosphorus).
(2) The “novel sugar- and phosphorus-containing fertilizer 2 (high-carbon type)” was applied. The novel sugar- and phosphorus-containing fertilizer per hectare of farmland was applied to the soil in three times, at 355.0 kg ha⁻¹ (which was equivalent to the total amount of carbon and phosphorus of 131.6 kg ha⁻¹, and the phosphorus-containing components of 19.6 kg P ha⁻¹).

The first fertilization was conducted when watering for seedling emergence of maize, at an application amount accounting for 40% of a total amount of the fertilizer (the amount of the novel sugar- and phosphorus-containing fertilizer was 142.0 kg ha⁻¹, which was equivalent to 52.6 kg ha⁻¹ in the total amount of carbon and phosphorus);
the second fertilization was conducted when first drip irrigation was completed after the emergence of maize, at an application amount accounting for 40% of a total amount of the fertilizer (the amount of the novel sugar- and phosphorus-containing fertilizer was 142.0 kg ha⁻¹, which was equivalent to 52.6 kg ha⁻¹ in the total amount of carbon and phosphorus); and
the third fertilization was conducted when third drip irrigation was completed after the emergence of maize; at an application amount accounting for 20% of a total amount of the fertilizer (the amount of the novel sugar- and phosphorus-containing fertilizer was 71.0 kg ha⁻¹, which was equivalent to 26.3 kg ha⁻¹ in the total amount of carbon and phosphorus).
4. The rest of the fertilization and field management were consistent with those of the actual production.

### Application Effect

According to the above method, a field experiment was conducted in Shihezi, Xinjiang in 2018, and a total of 5 treatments were set up.
Treatment one: as a control, herein no phosphate fertilizer was applied, and other fertilizers were supplied in sufficient quantities according to production routines;
treatment two: as a low-phosphorus group, herein phosphorus application was conducted at 19.6 kg P ha⁻¹ (45 kg P₂O₅ ha⁻¹);
treatment three: as a novel low-carbon fertilizer group, herein the novel sugar- and phosphorus-containing fertilizer 1 (low-carbon type) was applied at 195.0 kg ha⁻¹;
treatment four: as a novel high-carbon fertilizer group, herein the novel sugar- and phosphorus-containing fertilizer 2 (high-carbon type) was applied at 355.0 kg ha⁻¹; and
treatment five: as a high-phosphorus group, herein phosphorus was applied at 52.4 kg P ha⁻¹ (120 kg P₂O₅ ha⁻¹).

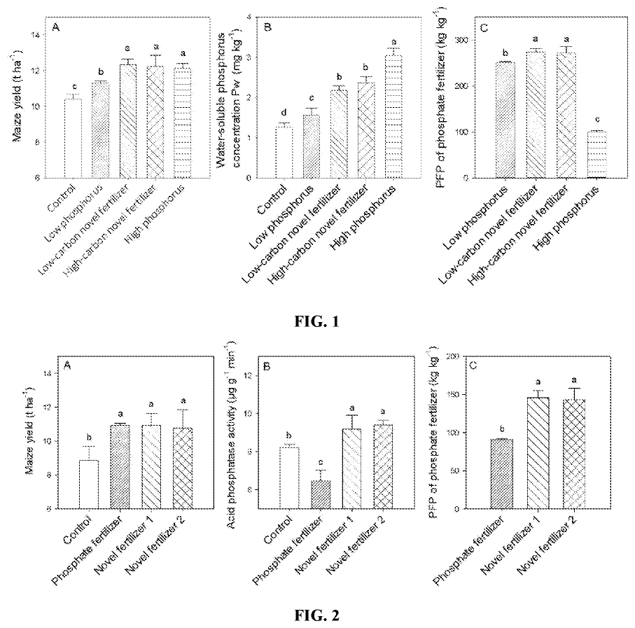

Experimental results were shown in FIGS. 1A-C. The maize treated with the novel fertilizer had a significantly higher yield than that of the no-phosphorus and low-phosphorus treatments, reaching a same yield level as that of the high-phosphorus treatment (FIG. 1A). The total input amount of phosphate fertilizer in low-carbon novel fertilizer and high-carbon novel fertilizer treatments was equal to that of the low-phosphorus treatment, but the yield increased significantly. Under the same phosphorus application rate, the application of novel low-carbon and high-carbon fertilizers increased the soil water-soluble phosphorus by 39% and 51%, respectively (FIG. 1B), and increased the PFP of phosphate fertilizer by 9.1% and 8.3%, respectively (FIG. 1C). Overall, compared with the high-phosphorus treatment, the application of the novel sugar- and phosphorus-containing fertilizer increased the PFP of phosphate fertilizer by an average of 1.7 times under the same yield (FIG. 1C). Overall, the application of the novel sugar- and phosphorus-containing fertilizer significantly increased the bioavailability of soil phosphorus and improved the phosphorus utilization efficiency of crops. This shows that the application of the novel sugar- and phosphorus-containing fertilizer of the present disclosure can maintain a high yield of crops under proper phosphorus reduction, which is of great significance to reduce the application amount of phosphate fertilizer while increasing the application efficiency in production.

### Example 2 Novel Sugar- and Phosphorus-Containing Fertilizer for Furrow Dressing of Spring Maize

1. In this example, the novel sugar- and phosphorus-containing fertilizer included the following components with corresponding carbon-to-phosphorus ratios:

The novel sugar- and phosphorus-containing fertilizer 1 (glucose) included: at a carbon-to-phosphorus ratio of 3.66:1, 300 parts of glucose containing 40% carbon, which was equivalent to 120 parts of carbon), and 125 parts of monoammonium phosphate (containing 60% P₂O₅, which was equivalent to 32.7 parts of phosphorus).

The novel sugar- and phosphorus-containing fertilizer 2 (sugarcane molasses) included: at a carbon-to-phosphorus ratio of 3.66:1, 353 parts of glucose (purchased from Jinan Xinkang New Material Co., Ltd., as a molasses powder with a saccharinity of 85%; containing 34% carbon, which was equivalent to 120 parts of carbon), and 125 parts of monoammonium phosphate (containing 60% P₂O₅, which was equivalent to 32.7 parts of phosphorus)
2. The preparation and application methods included:

The glucose and the sugarcane molasses powder of the above specific portion were mixed uniformly with the monoammonium phosphate separately to obtain a novel sugar- and phosphorus-containing fertilizer powder. A 7 cm to 15 cm deep furrow was dug near the root system of the crops, the novel sugar- and phosphorus-containing fertilizer powder was spread evenly in the furrow, and the soil was covered and irrigated in time.
3. The spring maize with a target yield of 10.5 t ha⁻¹ was taken as an example.

The application method of the novel sugar- and phosphorus-containing fertilizer included a type of the novel fertilizer, a total amount of the fertilizer during the whole growth period, and amounts during different growth periods.
(1) The “novel sugar- and phosphorus-containing fertilizer 1 (glucose)” was applied. The novel sugar- and phosphorus-containing fertilizer per hectare of farmland was applied to the soil in two times, at 425.0 kg ha⁻¹ (which was equivalent to the total amount of carbon and phosphorus of 152.7 kg ha⁻¹, and the phosphorus-containing components of 32.7 kg P ha⁻¹).

When sowing maize, the fertilization was applied along with a seed fertilizer, at an application amount accounting for 40% of a total amount of the fertilizer (the amount of the novel sugar- and phosphorus-containing fertilizer was 170.0 kg ha⁻¹, which was equivalent to 61.1 kg ha⁻¹ in the total amount of carbon and phosphorus);

When topdressing the maize at a jointing stage, the fertilization was applied at an application amount accounting for 60% of a total amount of the fertilizer (the amount of the novel sugar- and phosphorus-containing fertilizer was 255.0 kg ha⁻¹, which was equivalent to 91.6 kg ha⁻¹ in the total amount of carbon and phosphorus).
(2) The “novel sugar- and phosphorus-containing fertilizer 2 (sugarcane molasses)” was applied. The novel sugar- and phosphorus-containing fertilizer per hectare of farmland was applied to the soil in two times, at 478.1 kg ha⁻¹ (which was equivalent to the total amount of carbon and phosphorus of 152.7 kg ha⁻¹, and the phosphorus-containing components of 32.7 kg P ha⁻¹),

When sowing maize, the fertilization was applied along with a seed fertilizer, at an application amount accounting for 40% of a total amount of the fertilizer (the amount of the novel sugar- and phosphorus-containing fertilizer was 191.3 kg ha⁻¹, which was equivalent to 61.1 kg ha⁻¹ in the total amount of carbon and phosphorus);

When topdressing the maize at a jointing stage, the fertilization was applied at an application amount accounting for 60% of a total amount of the fertilizer (the amount of the novel sugar- and phosphorus-containing fertilizer was 286.8 kg ha⁻¹, which was equivalent to 91.6 kg ha⁻¹ in the total amount of carbon and phosphorus).
4. The rest of the fertilization and field management were consistent with those of the actual production.

### Application Effect

According to the above method, a field experiment was conducted at the Shangzhuang Experimental Station of China Agricultural University, and a total of 4 treatments were set up. Treatment one: as a control, herein no phosphate fertilizer was applied, and other fertilizers were supplied in sufficient quantities according to production routines; treatment two: as a phosphate fertilizer group, herein phosphorus application was conducted at 52.4 kg P ha⁻¹ (120 kg P₂O₅ ha⁻¹); treatment three: as a novel fertilizer 1 group, herein the “novel sugar- and phosphorus-containing fertilizer 1 (glucose)” was applied at 425.0 kg ha⁻¹; and treatment four: as a novel fertilizer 2 group, herein the “novel sugar- and phosphorus-containing fertilizer 2 (sugarcane molasses)” was applied at 478.1 kg ha⁻¹.

Experimental results were shown in FIGS. 2A-C, The application of the novel sugar- and phosphorus-containing fertilizer increased the yield by an average of 22% compared with that of the control treatment (FIG. 2A). Compared with the application of phosphate fertilizer, the application of the novel sugar- and phosphorus-containing fertilizer reduced the amount of phosphate fertilizer by 37.5%, While the maize yield did not decrease (FIG. 2A). After applying the novel sugar- and phosphorus-containing fertilizer, the soil acid phosphatase activity increased by an average of 14.5% compared with that of the control without phosphorus application, and increased by 45.5% compared with that of the application of phosphate fertilizer (FIG. 2B). Meanwhile, the PFP of phosphate fertilizer in the treatment with the novel sugar- and phosphorus-containing fertilizer was 59% higher than that in the treatment with phosphate fertilizer (FIG. 2C). This shows that in agricultural production, the fertilizer of the present disclosure can effectively regulate the activity of phosphorus-dissolving microorganisms (mineralized organic phosphorus), and improve the phosphorus utilization efficiency of crops.

### Example 3 Novel Sugar- and Phosphorus-Containing Fertilizer for Drip Irrigation of Cotton

1. In this example, the novel sugar- and phosphorus-containing fertilizer included the following components with corresponding carbon-to-phosphorus ratios:

The novel sugar- and phosphorus-containing fertilizer 1 (low-carbon type) included: at a carbon-to-phosphorus ratio of 1.44:1, 85 parts of glucose (containing 40% carbon, which was equivalent to 34 parts of carbon), and 90 parts of monoammonium phosphate (containing 60% P₂O₅, which was equivalent to 23.6 parts of phosphorus).

The novel sugar- and phosphorus-containing fertilizer (high-carbon type) included: at a carbon-to-phosphorus ratio of 4.58:1, 180 parts of glucose (containing 40% carbon, which was equivalent to 72 parts of carbon), and 60 parts of monoammonium phosphate (containing 60% P₂O₅, which was equivalent to 15.7 parts of phosphorus).
2. The preparation and application methods included:

The drip irrigation was conducted. During the drip irrigation, the glucose and the monoammonium phosphate of the above parts were fully mixed in proportion, to obtain novel sugar- and phosphorus-containing fertilizer powders with low carbon and high carbon. The novel sugar- and phosphorus-containing fertilizer powders were added into a fertilization tank along with other fertilizers, stirred and mixed evenly, and then subjected to the drip irrigation along with water. The novel sugar- and phosphorus-containing fertilizer 1 (low-carbon type) was applied when watering for seedling emergence, and the novel sugar- and phosphorus-containing fertilizer 2 (high-carbon type) was applied when first drip irrigation was completed after the emergence of maize.
3. A planting mode of the cotton by drip irrigation under mulch with a target lint yield of 2.25 t ha⁻¹ was taken as an example.

The application method of the novel sugar- and phosphorus-containing fertilizer included a type of the novel fertilizer, a total amount of the fertilizer during the whole growth period, and amounts during different growth periods.

Throughout the growth period of cotton, a total of 415.1 kg ha⁻¹ of the novel sugar- and phosphorus-containing fertilizer 1 (low-carbon type) and the novel sugar- and phosphorus-containing fertilizer 2 (high-carbon type) were applied (which was equivalent to the total amount of carbon and phosphorus of 145.3 kg ha⁻¹, and the phosphorus-containing components of 39.3 kg P ha⁻¹).

The novel sugar- and phosphorus-containing fertilizer 1 (low-carbon type) was applied to the soil in one time when watering for seedling emergence, at 175.1 kg ha⁻¹ (which was equivalent to the total amount of carbon and phosphorus of 57.6 kg ha⁻¹, and the phosphorus-containing components of 23.6 kg P ha⁻¹).

The novel sugar- and phosphorus-containing fertilizer 2 (high-carbon type) was applied to the soil in one time when first drip irrigation was completed after the emergence of maize, at 240.0 kg ha⁻¹ (which was equivalent to the total amount of carbon and phosphorus of 87.7 kg ha⁻¹, and the phosphorus-containing components of 15.7 kg P ha⁻¹)
4. The rest of the fertilization and field management were consistent with those of the actual production.

### Application Effect

According to the above method, a field experiment was conducted Shihezi, Xinjiang, and a total of 3 treatments were set up. Treatment one: as a control, herein no phosphate fertilizer was applied, and other fertilizers were supplied in sufficient quantities according to production routines; treatment two: as a phosphate fertilizer group, phosphorus application was conducted at 52.4 kg P ha⁻¹ (120 kg P₂O₅ ha⁻¹); and treatment three: as a novel fertilizer group, herein the novel sugar- and phosphorus-containing fertilizer 1 (low-carbon type) was applied at 175.1 kg ha⁻¹ when watering for seedling emergence, and the novel sugar- and phosphorus-containing fertilizer 2 (high-carbon type) was applied at 240.0 kg ha^{'11} when first drip irrigation was completed after the emergence of maize.

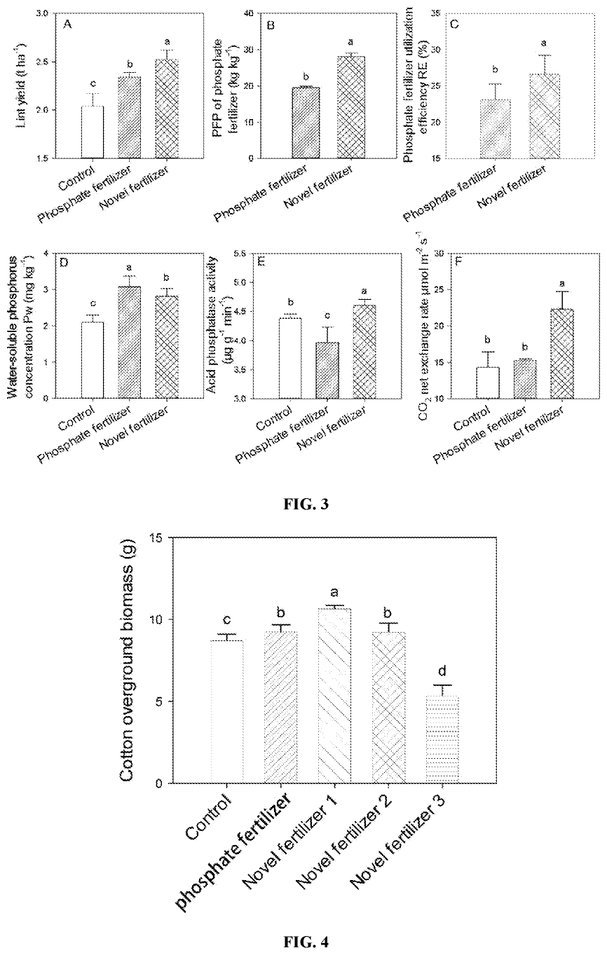

Experimental results were shown in FIGS. 3A-F. The lint yield increased by 23.8% after applying the novel sugar- and phosphorus-containing fertilizer compared with that of the control; under the condition of reducing phosphorus by 25%, the lint yield increased by 7.7% after applying the novel fertilizer compared with that of the phosphate fertilizer (FIG. 3A). Under the same yield level, the application of the novel sugar- and phosphorus-containing fertilizer had a 43.6% increase in the PFP of phosphate fertilizer compared with that of the application of phosphate fertilizer (FIG. 3B), and a 3.6% increase in the utilization efficiency of phosphate fertilizer (FIG. 3C). Compared with the control, the water-soluble phosphorus concentration, acid phosphatase activity, and soil respiration increased by 14.8%, 5.0%, and 55.7%, respectively, after applying the novel sugar- and phosphorus-containing fertilizer. Compared with the phosphate fertilizer treatment, soil acid phosphatase activity and soil respiration increased by 16.2% and 46.3%, respectively, after applying the novel fertilizer (FIG. 3D, FIG. 3E, FIG. 3F).The above results indicate that the application of novel fertilizer has improved the activity of soil microorganisms. The phosphatase activity is significantly enhanced, the soil water-soluble phosphorus concentration is significantly increased, and the soil phosphorus supply capacity is strengthened, such that the crop yield and phosphorus utilization efficiency are improved.

### Example 4 Novel Sugar- and Phosphorus-Containing Fertilizer for Application of Potted Cotton

1. In this example, the novel sugar- and phosphorus-containing fertilizer included the following components with corresponding carbon-to-phosphorus ratios:

The novel sugar- and phosphorus-containing fertilizer 1 included: at a carbon-to-phosphorus ratio of 6.58:1, 375 parts of glucose (containing 40% carbon, which was equivalent to 150 parts of carbon), and 100 parts of potassium dihydrogen phosphate (containing 22.79% phosphorus, which was equivalent to 22.79 parts of phosphorus).

The novel sugar- and phosphorus-containing fertilizer 2 included: at a carbon-to-phosphorus ratio of 13.16:1, 750 parts of glucose (containing 40% carbon, which was equivalent to 300 parts of carbon), and 100 parts of potassium dihydrogen phosphate (containing 22.79% phosphorus, which was equivalent to 22.79 parts of phosphorus).

The novel sugar- and phosphorus-containing fertilizer 3 included: at a carbon-to-phosphorus ratio of 21.94:1, 1250 parts of glucose (containing 40% carbon, which was equivalent to 500 parts of carbon), and 100 parts of potassium dihydrogen phosphate (containing 22.79% phosphorus, which was equivalent to 22.79 parts of phosphorus).
2. The preparation and application methods included:

The above amount of glucose and potassium dihydrogen phosphate were mixed with the soil in proportion, and then sowing was conducted.
3. The potted cotton was taken as an example.

4.75 g kg⁻¹ of the novel sugar- and phosphorus-containing fertilizer 1. 8.50 g kg⁻¹ of the novel sugar- and phosphorus-containing fertilizer 2, and 13.50 g kg⁻¹ of the novel sugar- and phosphorus-containing fertilizer 3 were mixed with the soil, followed by conducting sowing. Two seedlings were planted per pot, and then harvested after 80 d of cotton growth.

### Application Effect

According to the above method, a pot experiment was conducted in a greenhouse of China Agricultural -University, and a total of 5 treatments were set up. Treatment one: as a control, herein no phosphate fertilizer was applied; treatment two: as a phosphate fertilizer group, herein 0.228 g P kg⁻¹ of phosphorus was applied; treatment three: as a novel sugar- and phosphorus-containing fertilizer 1 group, herein 4.75 g kg⁻¹ of the novel sugar- and phosphorus-containing fertilizer was applied; treatment four: as a novel sugar- and phosphorus-containing fertilizer 2 group, herein 8.50 kg⁻¹ of the novel sugar- and phosphorus-containing fertilizer was applied; and treatment five: as a novel sugar- and phosphorus-containing fertilizer 3 group, herein 13.50 g kg⁻¹ of the novel sugar- and phosphorus-containing fertilizer was applied.

Experimental results were shown in FIG. 4. Compared with the control, the application of phosphate fertilizer significantly increased the cotton biomass. The cotton biomass was significantly higher than that of the control treatment when the carbon-to-phosphorus ratios of the novel sugar- and phosphorus-containing fertilizers were 6.58:1 and 13.16:1. However, when the carbon-to-phosphorus ratio of the novel sugar- and phosphorus-containing fertilizer was 21,94:1, the growth of cotton was greatly inhibited, and the aboveground biomass was significantly lower than that of the control and phosphorus application treatments. The above results show that the novel sugar- and phosphorus-containing fertilizer has a carbon-to-phosphorus ratio that should not exceed 21.94:1.

### INDUSTRIAL APPLICATION

In the present disclosure, through a large number of studies, it has been found that the carbon-containing compound may be mixed with the phosphorus-containing chemical fertilizer according to a mass ratio of carbon and phosphorus (i.e., the carbon-to-phosphorus ratio) of (1-15):1, and then applied to the soil. This can significantly increase the activity of indigenous phosphorus-solubilizing functional microorganisms in the soil, increase the availability of phosphorus in the soil, and then promote crop growth and improve the utilization efficiency of phosphate fertilizer. For example, through simulation experiments, it was found that when a mixture of chemical phosphate fertilizer and carbon-containing compound was applied at a carbon-to-phosphorus ratio of (1-13.3):1, soil microbial activity and phosphatase activity were significantly increased, and crop growth and phosphorus uptake efficiency were significantly improved. In field experiments, it was found that the chemical phosphate fertilizer containing 32.67 kg of phosphorus and the carbon-containing compound containing 48 kg to 180 kg of carbon could be mixed per hectare of farmland (with a corresponding carbon-to-phosphorus ratio ranged from (1.5-5.5):1). At this time, soil respiration was strengthened, soil phosphatase activity and water-soluble phosphorus content were enhanced, and crop yield was significantly increased. The studies also found that when the carbon-phosphorus input ratio reached 21.9:1, the growth of cotton was significantly inhibited.

In summary, the novel fertilizer provided by the present disclosure contains a carbon source that stimulates the growth and activity of microorganisms, After application, the novel fertilizer may regulate the phosphorus-solubilizing activity of soil microorganisms, improve the phosphorus utilization efficiency, and increase the crop yield.

1. A sugar- and phosphorus-containing fertilizer, comprising a water-soluble carbon-containing compound and a phosphorus-containing compound; wherein
a carbon element in the water-soluble carbon-containing compound and a phosphorus element in the phosphorus-containing compound are at a mass ratio of (1-15):1.

2. The fertilizer according to claim 1, wherein the carbon element in the water-soluble carbon-containing compound and the phosphorus element in the phosphorus-containing compound are at a mass ratio of (1-4):1 or (4-15):1.

3. The fertilizer according to claim 1, wherein the water-soluble carbon-containing compound is at least one selected from a group consisting of glucose, sucrose, sugarcane molasses, and beet molasses; and
the sugarcane molasses and the beet molasses each have a saccharinity of 40% to 100%, specifically 85%.

4. The fertilizer according to claim 1, wherein the phosphorus-containing compound is at least one selected from the group consisting of phosphoric acid and a phosphate;
the phosphate is at least one selected from the group consisting of monoammonium phosphate, diammonium phosphate, potassium dihydrogen phosphate, urea phosphate, and ammonium polyphosphate; and
the ammonium polyphosphate has a polymerization degree of 2 to 10.

5. The fertilizer according to claim 1, wherein the sugar- and phosphorus-containing fertilizer is prepared from the water-soluble carbon-containing compound, the phosphorus-containing compound, and water; and
the water and the water-soluble carbon-containing compound are at a mass ratio of (1-3):10.

6. A method for preparing the sugar- and phosphorus-containing fertilizer according to claim 1, comprising:
mixing the water-soluble carbon-containing compound, the phosphorus-containing compound, and the water uniformly according to a proportion to obtain the sugar- and phosphorus-containing fertilizer.

7. A method for fertilization using the sugar- and phosphorus-containing fertilizer according to claim 1.

8. The method according to claim 7, wherein during the fertilization, the sugar- and phosphorus-containing fertilizer is applied at 90 kg to 525 kg per hectare of farmland.

9. The method according to claim 7, wherein the fertilization is conducted on maize, cotton, or alfalfa;
the fertilization is conducted 1 to 3 times; and
the fertilization is conducted by drip irrigation, furrow dressing, or hole application.

10. The method according to claim 7, comprising using the sugar- and phosphorus-containing fertilizer to achieve any one of the following effects, wherein the effects comprise:
a, improving an activity of indigenous phosphorus-solubilizing functional microorganisms in the soil;
b, increasing availability of phosphorus in the soil;
c, promoting crop growth; and
d, improving a utilization efficiency of a phosphate fertilizer.

11. The fertilizer according to claim 2, wherein the water-soluble carbon-containing compound is at least one selected from a group consisting of glucose, sucrose, sugarcane molasses, and beet molasses; and
the sugarcane molasses and the beet molasses each have a saccharinity of 40% to 100%, specifically 85%.

12. The fertilizer according to claim 4, wherein the carbon element in the water-soluble carbon-containing compound and the phosphorus element in the phosphorus-containing compound are at a mass ratio of (1-4):1 or (4-15):1.

13. The fertilizer according to claim 4, wherein the water-soluble carbon-containing compound is at least one selected from a group consisting of glucose, sucrose, sugarcane molasses, and beet molasses; and
the sugarcane molasses and the beet molasses each have a saccharinity of 40% to 100%, specifically 85%.

14. The fertilizer according to claim 5, wherein the carbon element in the water-soluble carbon-containing compound and the phosphorus element in the phosphorus-containing compound are at a mass ratio of (1-4):1 or (4-15):1.

15. The fertilizer according to claim 5, wherein the water-soluble carbon-containing compound is at least one selected from a group consisting of glucose, sucrose, sugarcane molasses, and beet molasses; and
the sugarcane molasses and the beet molasses each have a saccharinity of 40% to 100%, specifically 85%.

16. The fertilizer according to claim 5, wherein the phosphorus-containing compound is at least one selected from the group consisting of phosphoric acid and a phosphate;
the phosphate is at least one selected from the group consisting of monoammonium phosphate, diammonium phosphate, potassium dihydrogen phosphate, urea phosphate, and ammonium polyphosphate; and
the ammonium polyphosphate has a polymerization degree of 2 to 10.

17. The method according to claim 6, wherein the carbon element in the water-soluble carbon-containing compound and the phosphorus element in the phosphorus-containing compo are at a mass ratio of (1-4):1 or (4-15):1.

18. The method according to claim 6, wherein the water-soluble carbon-containing compound is at least one selected from a group consisting of glucose, sucrose, sugarcane molasses, and beet molasses; and
the sugarcane molasses and the beet molasses each have a saccharinity of 40% to 100%, specifically 85%.

19. The method according to claim 6, wherein the phosphorus-containing compound is at least one selected from the group consisting of phosphoric acid and a phosphate;
the phosphate is at least one selected from the group consisting of monoammonium phosphate, diammonium phosphate, potassium dihydrogen phosphate, urea phosphate, and ammonium polyphosphate; and
the ammonium polyphosphate has a polymerization degree of 2 to 10.

20. The method according to claim 6, wherein the sugar- and phosphorus-containing fertilizer is prepared from the water-soluble carbon-containing compound, the phosphorus-containing compound, and water; and
the water and the water-soluble carbon-containing compound are at a mass ratio of (1-3):10.
